(19) United States
(12) Patent Application Publication
(10) Pub. No.: US 2003/0173860 A1
(43) Pub. Date: Sep. 18, 2003

(54) Method for making an electrically conductive wire and device thereof

(76) Inventor: Denis Even, Paris (FR)

Correspondence Address: Longacre & White, Suite 240, 6550 Rock Spring Drive, Bethesda, MD, 20817, US

(21) Appl. No.: 10/312,139

(22) PCT Filed: Apr. 30, 2002
(86) PCT No.: PCT/FR02/01501

(30) Foreign Application Priority Data
Apr. 30, 2001 (FR) 01/05832

(51) Int. Cl. H02K 1/12

(52) U.S. Cl. 310/259

(57) ABSTRACT

This method, for making an electrically conductive wire for a winding for a rotary electrical machine, from a conductive wire (14) having a generally round shape in transverse cross section, comprises the steps that consist of:

continuously drawing the round wire from a feed support, and

applying forces longitudinally on the wire on diametrically opposed zones in such a way as to form longitudinal flats (M, M′) on the latter.

The round wire has an electrically insulating envelope (E), and the forces are applied on the wire through the said envelope.

### TECHNICAL FIELD OF THE INVENTION

The present invention relates to a method making an electrically conductive wire for a winding for a rotary electrical machine, and also to an apparatus for performing such a method.

More particularly, the invention relates to a method of making an electrically conductive wire having longitudinal flats, from a conductive wire having a generally round shape in transverse cross section.

### STATE OF THE ART

One of the applications of such a wire is to form windings for a stator of an alternator or alternator starter for a motor vehicle, for starter or transformer inductors, for inductances, and so on.

In this connection, for the purpose of making this type of winding, and with a view to optimising the compactness of the machine of which it forms part or to improve cooling, it is often necessary to make use of a conductive wire formed with flats, that is to say a conductive wire having a transverse cross section which is flattened, which is for example in the form of a parallelogram, and in particular rectangular.

Although the use of such a wire is of particular advantage for making a winding, it does nevertheless have some major drawbacks.

Firstly, during manufacture of the wire, the velocity with which a wire of rectangular cross section is drawn through a machine, and in particular a machine for depositing an insulating enamel coating, is of necessity slower than the drawing velocity of a wire having a round cross section, and this is difficult to accommodate in high volume production lines.

In addition, in a said coating machine, the enamel is difficult to deposit in the corners of the conductive wire. This results in differences in enamel thickness on the surface of the wire.

In order to overcome this disadvantage, rounded corners are formed with a minimum radius of curvature, such as to enable the insulating coating to adhere properly. This nevertheless leads to a reduction in the overall usable cross section of the wire.

In this connection, for a wire having for example a rectangular cross section the thickness of which is 1.4 millimetres and its width 2 millimetres, and in which the radii of curvature at the angles are 0.5 millimetres, the overall cross section of the wire is 2.585 millimetres², which represents a loss of 8% as compared with a wire having right angled corners.

In addition, the use of a wire having flats makes winding and unwinding of the wire relatively difficult to perform in that the wire tends to twist if it is not perfectly guided. It is therefore essential to perform the conditioning operation on a turret, whereas a round wire can easily be coiled in a bin and withdrawn from the latter, without it being necessary to rotate the bin as the wire is drawn out.

Winding a flat wire on a turret, and unwinding it, therefore make it necessary to provide for rotation of the latter, which is not the case for a bin of round wire.

In addition, it is not easy to find in the marketplace turrets for flat wire having a weight greater than 80 Kg, whereas round wire bins can easily receive more than 200 or 300 Kg of wire, which reduces in proportion the frequency of stoppages of production.

Finally it will be noted that, whereas for a given cross section of round wire there is only one single diameter, for a given cross section of flat wire there exists a wide variety of configurations which may be envisaged, and this, in practice, prevents the producers and distributors of such wires from carrying any large amounts of stock.

### OBJECT OF THE INVENTION

The object of the invention is to overcome these drawbacks.

Accordingly, the invention provides a method of making an electrically conductive wire for a winding for a rotary electrical machine, from a conductive wire having a generally round shape in transverse cross section, characterised in that it comprises the steps that consist of:

continuously drawing the round conductive wire from a feed support, and

applying forces longitudinally on the wire on diametrically opposed zones in such a way as to form longitudinally flats on the latter,

and in that, the round wire having an electrically insulating envelope, the forces are applied on the wire through the said envelope.

The method according to the invention thus enables a flat wire to be obtained with advantage and at reduced cost, the wire being insulated by a coating which is for example of enamel, the said layer constituting an electrically insulating envelope. As to this, it is much easier and cheaper to deposit an insulating layer on a round wire than on a wire having at least one flat or having any other shape than a circular transverse cross section.

This method may also include one or more of the following features, taken separately or in any technically possible combinations:

after the step of applying the said forces in the direction of the thickness of the wire, additional forces are applied in the direction of the width of the wire, on diametrically opposed zones at right angles to the flats which have been formed, whereby to form a wire having a generally rectangular transverse cross sectional shape.

An insulated wire of generally rectangular transverse cross section, obtained in accordance with the method of the invention, enables a wound stator to be made economically with hairpin-type formers. Preferably these hairpin formers have two branches, defining conductive bars, which are introduced into the slots in the stator. Each of the slots can receive at least two conductors. Four branches are preferably inserted, in radial alignment, into each of the slots in the stator in such a way as to obtain, for example, a six-phase alternator. A generally rectangular transverse cross section enables the filling coefficient of the slots to be optimised.

additional forces are applied on diametrically opposed zones of the wire in the direction of the width of the wire simultaneously with the forces applied longitudinally in the direction of the thickness of the wire, whereby to form a wire having a rectangular shape in transverse cross section, with contiguous flats defining right angles.

Thus, the wires which are obtained have a perfectly rectangular cross section which enables the slots of the stator or rotor of a rotary machine to be filled with a high filling coefficient.

each of the said steps of applying the said forces consists in passing the wire between at least one pair of forming rolls;

the ratio between the length and the width of the cross section of the wire being less than or equal to two, each of the said steps of applying the said forces in the direction of the thickness and width of the wire consists in passing the wire between a single pair of forming rolls.

The invention is also directed to apparatus for making an electrically conductive wire for a winding for a rotary electrical machine from a conductor wire having a generally round shape in transverse cross section, characterised in that the said wire being provided with an electrically insulating envelope, the apparatus comprises at least one pair of forming rolls which are adapted to apply forces together through the said envelope on diametrically opposed zones of the wire, in such a way as to form flats on the latter, together with means for passing the wire between the said rolls.

Preferably, the apparatus comprises at least two pairs of forming rolls disposed respectively upstream and downstream in relation to the direction in which the wire is drawn, the pair of upstream rolls having a concave peripheral working surface.

### BRIEF DESCRIPTION OF THE DRAWINGS

Further objects, features and advantages of the invention will appear from the following detailed description, which is given by way of example only and with reference to the attached drawings, in which:

FIG. 1 is a view of an apparatus for making an electrically conductive wire in accordance with the invention;

FIG. 2 illustrates one phase in the shaping of the wire by the method according to the invention;

FIG. 3 illustrates another shaping phase in the method according to the invention;

FIG. 4 illustrates a further example of how the phase of shaping the wire in the method according to the invention is carried out;

FIG. 5 is a diagrammatic view seen in the direction of displacement of the wire, showing a further embodiment of an apparatus for making an electric wire, in particular a conductor, according to the invention;

FIG. 6 is a diagrammatic view of an alternator having a stator which is wound with a wire made according to the invention;

FIG. 7 is a perspective view of the stator of FIG. 1, with the conductive elements removed so as to show the slots in the stator;

FIG. 8 is a diagrammatic representation of one example of the connection of the phase windings;

FIG. 9 is a view in transverse cross section showing the arrangement of the conductive elements made in accordance with the invention, in a slot in the stator of FIG. 7.

### DESCRIPTION OF PREFERRED EMBODIMENTS OF THE INVENTION

FIG. 1 shows an apparatus for making a wire which has longitudinal flats and which is designated by the general reference numeral 10.

The wire is made from a wire of round section which is drawn continuously from a supply bin 12 in which it is coiled.

The flat wire to be made is for example intended for forming windings for rotary electrical machines.

To make such a wire, the starting material is a round section wire comprising a central core A of electrical conductive material, for example copper, coated with a layer E of insulating material which constitutes an insulating electrical envelope. This insulating electrical envelope is preferably an enamel.

As can be seen in FIG. 1, the apparatus consists essentially of a set of forming rolls which are adapted so that together they exert forces on the wire for shaping it, together with means (not shown) for feeding the wire between these rolls in the direction indicated by the arrow F, these means consisting for example of a motorised roller feed.

In the embodiment shown, the wire to be made has a cross section which is rectangular in transverse cross section.

Thus, the wire is passed between two sets of pairs of forming rolls, namely a first set of pairs P1, P2, P3 and P4 of forming rolls, the rolls in each pair being adapted to exert together longitudinal forces on diametrically opposed zones of the wire 14, in such a way as to form generally parallel flats in those zones, together with a second set of forming rolls P′1 and P′2, the axes of which are at right angles to the axes of the first set of forming rolls P1, P2, P3 and P4, whereby to create lateral flats at right angles to the flats which are formed by the first set of rolls.

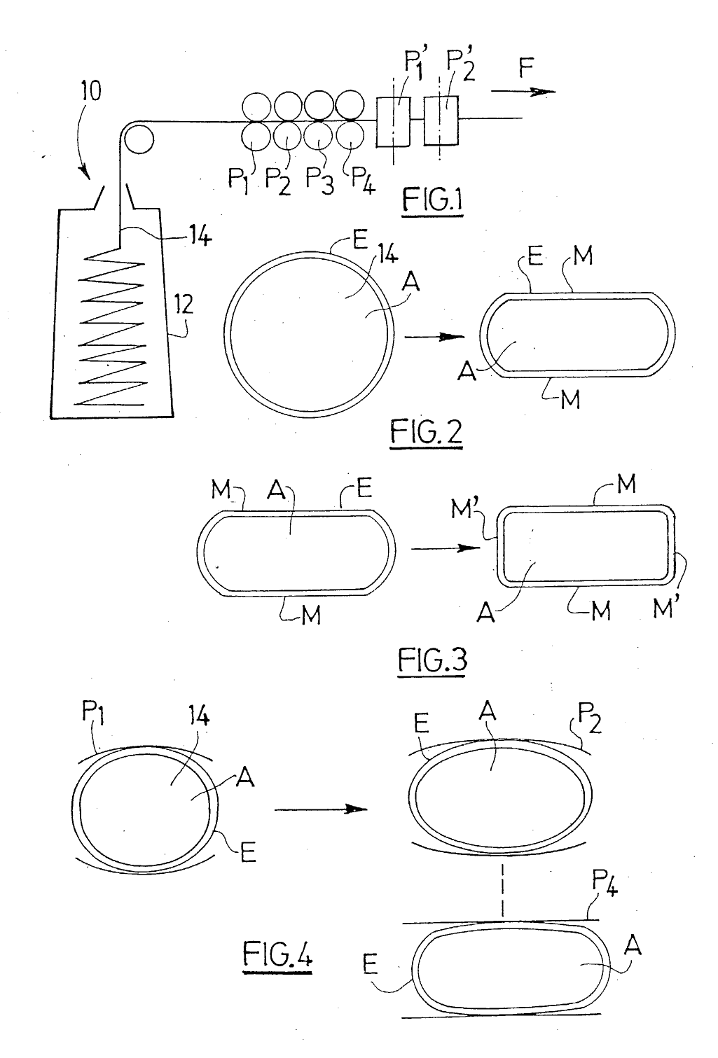

With reference to FIGS. 2 and 3, for an elementary portion of wire, this shaping operation is carried out in two successive shaping phases, in the course of which the portion of wire passes between two assemblies of forming rolls, for forming corresponding flats M and M′ respectively.

It will be noted that the forces exerted in this shaping operation are exerted directly on the enamel layer surrounding the conductor of the wire 14.

Thus for each set of rolls, a plurality of sets of rolls are preferably used, each exerting a squeezing force which is weak enough not to alter the enamel layer which constitutes the electrically insulating envelope.

More particularly, if the ratio between the length and width of the transverse section of the finished conductive wire is greater than 2, then for each shaping phase, several pairs of forming rolls are used.

It will also be noted that, depending on the form of the finished product, it is possible to use a single set of rolls.

In this connection, if it is appropriate simply to form two diametrically opposed flats on the wire, a single assembly, consisting of one or more pairs of rolls, is used for exerting forces on two diametrically opposed zones of the wire, in such a way as to form two diametrically opposed longitudinal flats.

Referring finally to FIG. 4, in the case where the configuration of the finished wire makes it necessary to use, for each shaping phase, a plurality of sets of rolls positioned in series in the downstream direction with reference to the direction of movement of the wire, then as regards the upstream rolls which are used, these are preferably forming rolls of which the external peripheral working surface, that is to say the surface through which the forces are exerted on the wire, is concave in form, whereas the downstream rolls have a flat working surface.

In this way, the level of stress applied on the insulating enamel layer is considerably reduced.

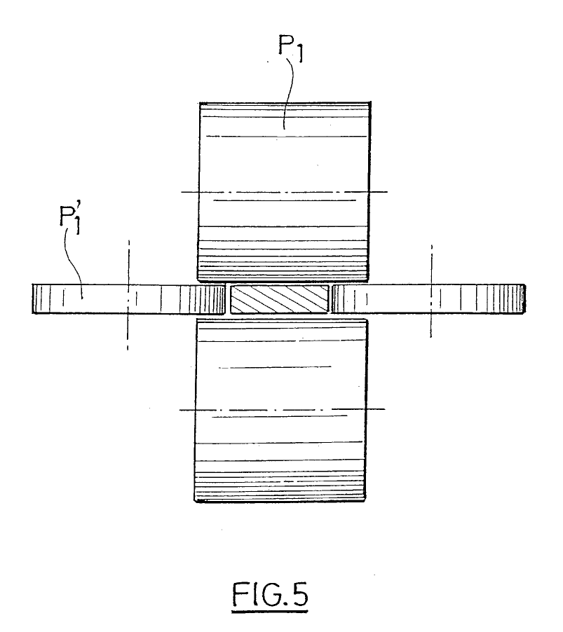

FIG. 5 illustrates a further embodiment of the apparatus for making a wire of rectangular transverse cross section from a round section wire. In the case of FIG. 5, the final rectangular form is obtained directly by disposing the two pairs of rolls, for example P1, P′1 as in FIG. 1, the axes of rotation of which are at right angles, so that the axes are in the same plane at right angles to the direction of travel of the wire, that is to say they act in the direction of the thickness and the direction of the width at the same time. The rolls P1 which flatten across the thickness are motorised to enable the wire to be advanced as it is formed. On the other hand, the rolls P′1 which deform the wire across its width may be unmotorised. The apparatus thus described in the embodiment of FIG. 5 has the advantage that it enables a wire of rectangular transverse cross section to be formed from a round wire having an insulating envelope, with the flats M and M′ of the finished wire defining right angles. These right angles are obtained due to the fact that the pairs of rolls act simultaneously on the four faces defining the flats M, M′, thereby avoiding any torsion in the wire which could occur in the case where the lateral flats were obtained by means of the second set of rolls P′1, P′2 acting after the first set of forming rolls P1, P2, P3 and P4 had formed the flats of greater width. This version also offers the advantage that it provides an apparatus for making a wire which is very compact, because the axes of the two sets of rolls P1, P2 . . . and P′1, P′2 are in the same plane.

The rolls P1 extend axially on either side of the wire by a distance at least equal to the thickness of the wire. The rolls P′1 lie between the rolls P1.

In general terms, as regards the diameter of the rolls, it is of advantage to give the rolls P1, P2 . . . , which act in the direction of the thickness, a diameter which is at least sixty times the thickness of the flattened wire, and to give the rolls P1′, P2′ . . . that work in the direction of the width a diameter which is more than thirty times the width of the flattened wire. The use of rollers of large diameter is of advantage because it enables the velocity of rotation of the rolls to be reduced, so producing reduced heating of the rolls and a reduction in wear. In this connection, the forces are distributed over a larger surface. Another advantage lies in the fact that the deformation is more progressive, and is therefore less severe on the enamel coating.

The invention can be applied with advantage to alternators or alternator starters for motor vehicles having a stator, a claw-type rotor with N pairs of poles disposed within the stator and carrying an excitation winding formed with an input wire and an output wire, the stator comprising a cylindrical body, a plurality of phases each of which consists of a plurality of electrically conductive elements mounted in series along the periphery of the stator between an inlet and an outlet, the cylindrical body having in its radially inner face radial slots for receiving at least four conductive phase elements which are juxtaposed in the slot in the radial direction so as to form at least four layers of conductive elements, each conductive element being a hairpin-type former extending between two slots and comprising a first branch which is placed in a slot in a predetermined layer, and a second branch disposed in another slot in a predetermined layer, with, between the two branches and on one axial side of the body of the stator, a head which defines a U when seen in the peripheral direction, while on the other side of the body a free end of a branch of a conductive element is electrically connected to the free end of a branch of another conductive element, that half of the conductive elements that are engaged by means of their first branches in a slot being engaged through their respective second branches in a common further slot, each defining the said U-shapes between the two slots.

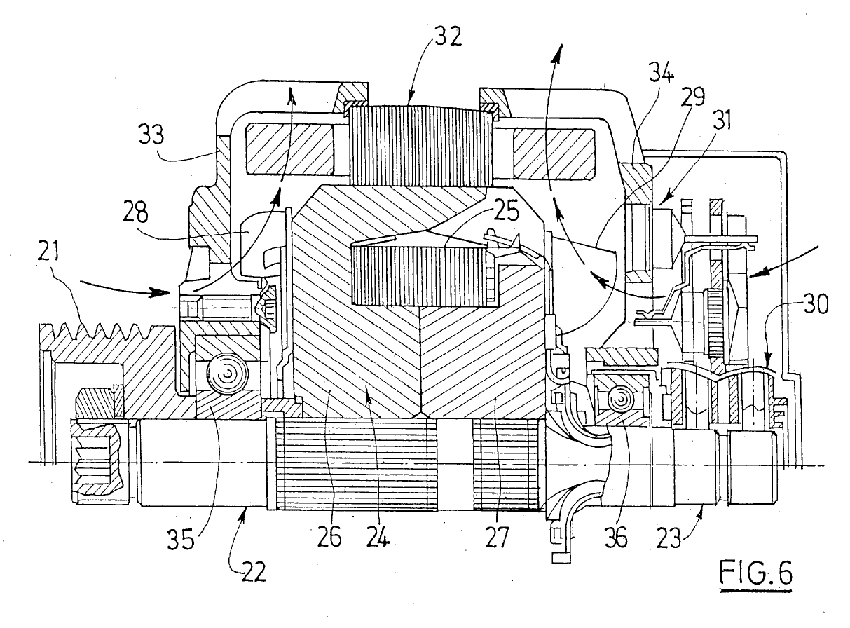

By way of example, FIG. 6 shows the general structure of an alternator for a motor vehicle. The alternator comprises, going from left to right in FIG. 6, that is to say from front to rear, a drive pulley 21 which is fixed to the front end of a shaft 22, the rear end of which carries slip rings (not shown) of a collector 23. The axis of the shaft 22 is the axis of rotation of the machine.

The shaft 22 carries the rotor 24, being in the centre of the latter and fixed to it, the rotor having an excitation winding 25 the ends of which are connected through connections to the collector 23. The rotor 4 in this example is a claw-type rotor of the Lundell type, and accordingly comprises two pole wheels, namely a front pole wheel 26 and a rear pole wheel 27, each of which carries a fan, namely a front fan 28 and a rear fan 29. Each wheel 26, 27 comprises a radial plate at right angles to the axis of the shaft 22. At the outer periphery of the radial plates there are formed axially extending integral teeth. The teeth are trapezoidal in form and are chamfered. The teeth of one of the wheels are directed towards the other wheel, and are offset angularly with respect to the teeth of the said other wheel. When the winding 25 is energised, the rotor 24 is magnetised and thus defines pairs of magnetic poles, each pole wheel accordingly comprising N north poles and N south poles, respectively, constituted by the teeth.

The regulator is connected to a current rectifying device 31, such as a diode bridge (two of which can be seen in FIG. 6), which it is itself connected to the outputs of the phase windings which are part of the stator 32 of the alternator.

The said fans 28, 29 are located in the vicinity, respectively, of a front bearing 33 and a rear bearing 34. The bearings 33, 34 have apertures for internal ventilation of the alternator by means of the fans 28, 29 when the assembly consisting of the fans 28, 29, rotor 24 and shaft 22 is driven in rotation by the pulley 21, which is coupled to the engine of the motor vehicle through a transmission device comprising at least one belt in engagement with the pulley 21. This ventilation cools the windings of the stator 32 and the winding 25, as well as the brush carrier 30 with its generator and the rectifying device 31. In FIG. 6, arrows represent the path followed by the cooling fluid, which is air in this example, through the various apertures in the bearings 33, 34 and inside the machine.

The rectifier 31, brush carrier 30, and a perforated protective cap (not given a reference numeral) are carried by, and fixed to, the bearing 34 in such a way that the rear fan 29 is more powerful than the front fan 28. In the known way, the bearings 33, 34 are connected together, in this example with the aid of screws, or, in another version, by means of bolts not shown, so that they constitute a casing or support which is adapted to be mounted on a fixed part of the vehicle.

Each of the bearings 33, 34 carries a central ball bearing 35, 36 for supporting rotatably in it the front and rear ends of the shaft 22 passing through the bearings, to carry the pulley 21 and the rings of the collector 23.

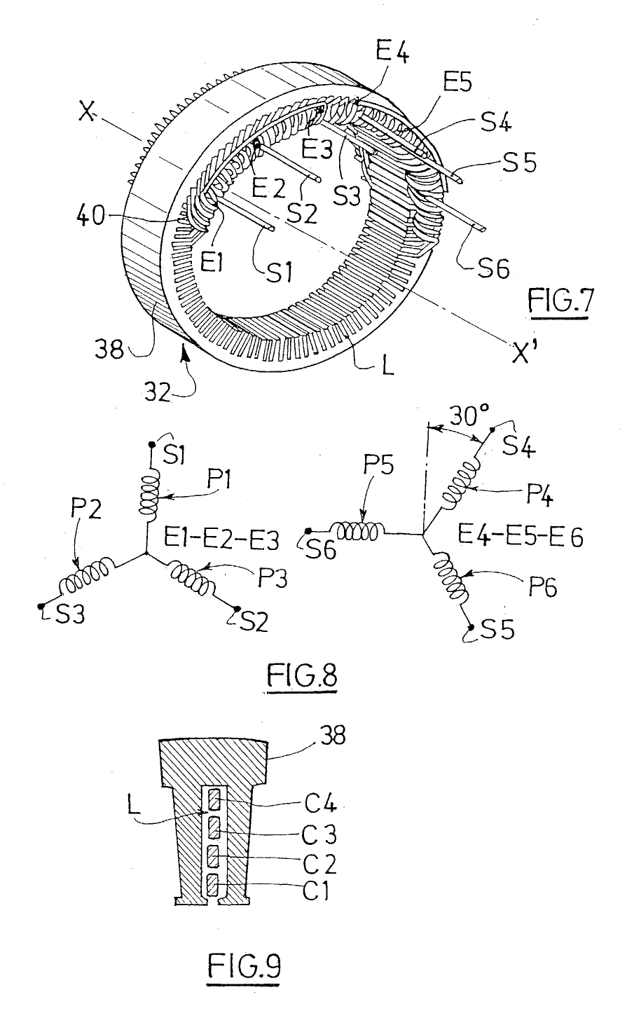

FIGS. 7 and 8 show the stator 32 which comprises a cylindrical body 38 with an axis X-X′ and two sets of three phases P1 to P3 and P4 to P6, constituting two sets of three phase windings offset by 30° electrical, and behaving like a six-phase winding seen from the side of the rectifier device. The expression “six-phase” is to be taken to mean two sets of three-phase windings offset by 30° electrical, each three-phase winding being star-wound with an independent neutral point.

Each phase P1 to P6 consists of a plurality of electrically conductive elements 40 which are connected in series along the periphery of the stator 32 between an input, E1 to E6 respectively, and an output S1 to S6 respectively, so as to constitute at least one phase winding per radial slot L, as is shown in FIG. 9.

Thus, as FIG. 9 shows, the cylindrical body 38, also referred to as the stack of laminations, comprises in its radially inner face radial slots L for receiving at least four conductive phase elements 40. The conductive elements 40 are juxtaposed in the slot L in the radial direction, in order to form at least four layers of conductive elements C1 to C4, in the order of increasing distance from the inner radial face of the body, as is shown in FIG. 8 in the case of slots with four conductive elements.

Preferably, the conductive elements C1 to C4 are made in accordance with the method described in accordance with the invention. Thus, the essentially rectangular form of the conductive elements C1 to C4 is obtained by continuously drawing the round conductive wire from a feed support 12, and by applying longitudinal forces on the wire in the direction of the thickness, on the diametrically opposed zones in such a way as to form longitudinal flats M on the latter, the round wire 14 having an electrically insulating envelope and the forces being applied on the wire through the said envelope. Then, after or simultaneously with the step of applying the said forces, additional forces are applied on diametrically opposed zones of the wire at right angles to the flats which have been formed, in the direction of the width of the wire, so as to form a wire which has an essentially rectangular shape in transverse cross section.

1. A method of making an electrically conductive wire for a winding for a rotary electrical machine, from a conductive wire (14) having a generally round shape in transverse cross section, characterised in that it comprises the steps that consist of:
continuously drawing the round conductive wire from a feed support (12), and
applying forces longitudinally on the wire on diametrically opposed zones in such a way as to form longitudinally flats (M, M′) on the latter,
and in that, the round wire (14) having an electrically insulating envelope, the forces are applied on the wire through the said envelope.

2. A method according to claim 1, characterised in that, after the step of applying the said forces in the direction of the thickness of the wire, additional forces are applied in the direction of the width of the wire, on diametrically opposed zones at right angles to the flats which have been formed, whereby to form a wire having a generally rectangular transverse cross sectional shape.

3. A method according to claim 1, characterised in that additional forces are applied on diametrically opposed zones of the wire in the direction of the width of the wire simultaneously with the forces applied longitudinally in the direction of the thickness of the wire, whereby to form a wire having a rectangular shape in transverse cross section, with contiguous flats (M, M′) defining right angles.

4. A method according to claim 1, characterised in that each of the said steps of applying the said forces consists in passing the wire between at least one pair of forming rolls (P1, P2, P4; P′1, P′2).

5. A method according to claim 4, characterised in that the ratio between the length and the width of the cross section of the wire being less than or equal to two, each of the said steps of applying the said forces in the direction of the thickness and width of the wire consists in passing the wire between a single pair of forming rolls.

6. Apparatus for making an electrically conductive wire for a winding for a rotary electrical machine from a conductor wire having a generally round shape in transverse cross section, characterised in that, the said wire being provided with an electrically insulating envelope (E), the apparatus comprises at least one pair of forming rolls (P1, P2, P3, P4; P′1, P′2) which are adapted to apply forces together through the said envelope (E) on diametrically opposed zones of the wire, in such a way as to form flats on the latter, together with means for passing the wire between the said rolls.

7. Apparatus according to claim 6, characterised in that it comprises at least two pairs of forming rolls (P1, P2, P3, P4; P′1, P′2) disposed respectively upstream and downstream in relation to the direction in which the wire is drawn, the pair of upstream rolls having a concave peripheral working surface.

8. Apparatus according to claim 6, characterised in that it comprises at least two pairs of forming rolls (P1, P′1), the axes of rotation of which are at right angles and which are disposed in such a way that the said axes are located in a common plane at right angles to the direction in which the wire is drawn.

9. Apparatus according to claim 6, characterised in that the pairs of rolls (P′1, P′2) that act in the direction of the width of the wire lie between the pairs of rolls (P1, P2) which act in the direction of the thickness of the wire.

10. Apparatus according to claim 6, characterised in that the rolls (P1, P2, P3, P4) which act in the direction of the thickness of the flattened wire have a diameter more than sixty times the thickness of the flattened wire.

11. Apparatus according to claim 6, characterised in that the rolls (P′1, P′2, P3′, P4′) acting in the direction of the width of the flattened wire have a diameter more than thirty times the width of the flattened wire.

12. Apparatus according to claim 6, characterised in that the rolls (P1, P2, P3, P4) acting in the direction of the thickness of the flattened wire are motorised, whereby to advance the wire during forming thereof.

13. An alternator for a motor vehicle comprising a stator (32), a claw-type rotor (24) with N pairs of poles disposed within the stator (32) and carrying an excitation winding (25), the stator (32) comprising a cylindrical body (38) and a plurality of phases, each of which consists of a plurality of electrically conductive elements (40) mounted along the periphery of the stator between an input (E) and an output (S), the cylindrical body (38) comprising, in its radially inner face, radial slots (L) for receiving at least two conductive phase elements (40) which are juxtaposed in the slot (L) in the radial direction so as to define at least two layers of conductive elements of essentially rectangular transverse cross section, each conductive element (40) having the form of a hairpin extending between two slots, characterised in that the conductive elements of essentially rectangular transverse cross section are made by the method according to one of claims 1 to 5.
